(19) United States
(12) Patent Application Publication
(10) Pub. No.: US 2024/0238979 A1
(43) Pub. Date: Jul. 18, 2024

(54) METHOD AND SYSTEM FOR CONTROLLING A TELEROBOTIC ROBOT

(71) Applicant: KUKA Deutschland GmbH, Augsburg (DE)

(72) Inventor: Juan David Munoz Osorio, Augsburg (DE)

(73) Assignee: KUKA Deutschland GmbH, Augsburg (DE)

(21) Appl. No.: 18/558,440

(22) PCT Filed: Apr. 22, 2022
(86) PCT No.: PCT/EP2022/060749

§ 371 Date: Nov. 1, 2023

(30) Foreign Application Priority Data
May 4, 2021 (DE) 10 2021 204 494.8

(51) Int. Cl. B25J 9/16

(52) U.S. Cl. CPC B25J 9/1689; B25J 9/1633; B25J 9/1669

(57) ABSTRACT

A method for controlling a telerobotic robot using an input device which has a movable actuator includes repeatedly: —commanding a target pose of a reference of the telerobotic robot, said reference being fixed to the robot, on the basis of a detected position of the actuator; and —commanding a target force of the actuator; wherein a contact operating mode is carried out if a contact is ascertained between the reference fixed to the robot and an obstacle in a contact direction, and a non-contact operating mode is carried out after said contact is no longer ascertained and/or before said contact is ascertained. In the contact operating mode, the target force has a contact force component of a virtual spring, said contact force component simulating a contact between the reference fixed to the robot and an obstacle, and the contact force component is omitted in the non-contact operating mode.

### CROSS-REFERENCE TO RELATED APPLICATIONS

This application is a national phase application under 35 U.S.C. § 371 of International Patent Application No. PCT/EP2022/060749, filed Apr. 22, 2022 (pending), which claims the benefit of priority to German Patent Application No. DE 10 2021 204 494.8, filed May 4, 2021, the disclosures of which are incorporated by reference herein in their entirety.

### TECHNICAL FIELD

The present invention relates to a method and a system for controlling a telerobotic robot with the aid of an input device which comprises a movable actuator, and a computer program or computer program product for carrying out the method.

### BACKGROUND

From internal practice, it is known to control a telerobotic robot with the aid of an input device which comprises a movable actuator. Target pose changes of a reference, fixed to the robot, of the telerobotic robot, for example its end effector or TCP, are commanded on the basis of a detected manual adjustment of the actuator by an operator and, conversely, target forces of the actuator are commanded on the basis of sensor-detected external forces at the robot-fixed reference, so that the operator experiences a direct haptic (force) feedback at the actuator.

### SUMMARY

It is an object of the present invention to improve the control of a telerobotic robot by means of an actuation of an actuator of an input device.

This object is achieved by a method, a system, and computer program or computer program product for carrying out a method as described herein.

According to one embodiment of the present invention, a method for controlling a telerobotic robot using an input device that comprises a movable actuator comprises the following steps, which are repeated, preferably several times, in one embodiment cyclically:
Commanding a target pose of a reference, fixed to the robot, of the telerobotic robot based on a detected position of the actuator manually effected by an operator in one embodiment; and
Commanding a target force of the actuator, in particular on the actuator.

By commanding target poses, in one embodiment the telerobotic robot can advantageously be controlled (more) precisely, and by commanding target forces a (more) advantageous, in particular (more) reliable, (more) ergonomic, and/or (more) intuitive operation of the actuator can be realized in one embodiment, and thus in one embodiment a teleoperation can be simplified and/or its reliability can be improved.

In one embodiment, the telerobotic robot comprises a ((tele)robotic) arm with at least three, in particular at least six, in one embodiment at least seven, joints or axes of motion. In one embodiment, the robot-fixed reference is stationary with respect to a distal end flange of the telerobotic robot (arm), in one embodiment, the robot-fixed reference comprises an end effector or TCP of the telerobotic robot (arm), and in particular may be an end effector or TCP of the telerobotic robot (arm).

In one embodiment, the actuator is spatially spaced from the telerobotic robot and/or a (robot) controller of the telerobotic robot. In one embodiment, the input device, in particular an input device controller, is connected in terms of signal to the telerobotic robot and/or a (robot) controller of the telerobotic robot, in one embodiment by a wired connection, which in one embodiment can increase reliability, and in another embodiment by a wireless connection, which in one embodiment can increase the flexibility and/or range. In one embodiment, the actuator is mounted movably, in particular via one or more joints, on a base of the input device, wherein a pose of the actuator relative to the base of the input device is detected in one embodiment, preferably by sensors, as the position of the actuator.

A pose in the sense of the present invention comprises, in one embodiment, a one-, two-, or three-dimensional position and/or a one-, two-, or three-dimensional orientation. In one embodiment, a position of the actuator is a pose of the actuator, in particular relative to a base of the input device. A force in the sense of the present invention can comprise, and can in particular be, an oppositely directed parallel force pair or torque. A controlling in the sense of the present invention can also be a closed-loop controlling.

In one embodiment, drives of the telerobotic robot adjust its axes or joints in order to approach the commanded target pose(s), wherein corresponding target joint displacements are determined in an embodiment in a manner known per se by means of inverse kinematics, optionally with redundancy resolution in a manner known per se.

In one embodiment, drives of the input device actuate the actuator in order to exert the commanded target force, in particular via the actuator, on an operator manually actuating the actuator.

According to one embodiment of the present invention, a contact operation mode is carried out, in particular switching takes place to a contact operation mode, if a contact of the robot-fixed reference with an obstacle in a contact direction is detected, and a non-contact operation mode is carried out after this contact is no longer detected and/or before this contact is detected, in one embodiment switching takes place to a non-contact operation mode if a contact of the robot-fixed reference with an obstacle in a contact direction is no longer detected.

According to one embodiment of the present invention, in the contact operating mode, the target force comprises a contact force component of a virtual spring, in particular a positive or pressure contact force component of a virtual (pressure) spring, which simulates a contact of the robot-fixed reference with an obstacle, in one embodiment a (rigid body) contact of a rigid robot-fixed reference with a rigid obstacle, and in one embodiment simulates a force in a direction opposite the contact direction on the robot-fixed reference, this contact force component being omitted in the non-contact operating mode.

As a result, in one embodiment, with respect to a force feedback of a sensor-determined external force at the robot-fixed reference on the actuator, or with respect to a commanding of a target force of the actuator, which corresponds to such a sensor-determined external force at the robot-fixed reference, an undesired impact effect due to a contact can be reduced, preferably avoided: in the event of such a force feedback, a (high) sensor-determined external force at the robot-fixed reference causes, with a certain delay, a corresponding (high) force at the actuator, which in turn causes a corresponding movement of the actuator, which in turn causes, with a certain delay, a corresponding (rebound) movement of the robot-fixed reference. Additionally or alternatively, in one embodiment, the invention can reduce, preferably avoid, damage to the telerobotic robot and/or an obstacle contacted by it with respect to a force feedback: in the case of such force feedback, for example, a flexible end effector or a soft obstacle can be bent before the operator feels or reacts to a correspondingly high force at the actuator. In one embodiment, an obstacle can also be a deliberately or intentionally contacted element in the environment, such as a workpiece or the like.

In one embodiment, the (virtual) stiffness of the virtual spring depends on the magnitude of the sensor-detected external force at the robot-fixed reference on the actuator, in one embodiment on the magnitude of the sensor-detected external force in or corresponding to the contact direction, in one embodiment in such a way that the stiffness increases with increasing external force, in particular with increasing external force in or corresponding to the contact direction. In one embodiment, a (magnitude of the) force corresponding to the direction of contact is a (magnitude of a) component of the force that seeks to cause a movement of the robot-fixed reference in the direction of contact or corresponds to such a direction of movement. As a result, in one embodiment a (more) advantageous, in particular (more) reliable, (more) ergonomic, and/or (more) intuitive operation can be realized, and thus in one embodiment a teleoperation can be simplified and/or its reliability improved.

In one embodiment, in the contact operating mode, a commanding of a movement of the robot-fixed reference in the contact direction is reduced compared with a commanding of a movement of the robot-fixed reference in the same direction in the non-contact operating mode, in a development it is suppressed, in one embodiment despite or even in the case of a position or movement of the actuator for effecting a corresponding movement of the robot-fixed reference.

In one embodiment, this allows damage to the telerobotic robot and/or an obstacle contacted by it to be (further) reduced, preferably avoided.

In one embodiment, a commanding of a movement of the robot fixed reference in a direction perpendicular to the contact direction is the same in the contact operating mode and in the non-contact operating mode. Additionally or alternatively, in one embodiment a commanding of a movement of the robot-fixed reference in a direction opposite to the contact direction is the same in the contact operating mode and in the non-contact operating mode.

In one embodiment, this can improve the handling of the telerobotic robot, in particular the operator of the input device or the actuator can react advantageously on contact, in particular can control the contacting telerobotic robot advantageously.

In one embodiment, the virtual spring does not cause a contact force component that corresponds to a force on the robot-fixed reference in the direction of the contact direction and/or perpendicular thereto, or the virtual spring only causes a pressure contact force component that corresponds to a force on the robot-fixed reference in a direction opposite to the contact direction.

In one embodiment, the operation can thereby be improved, in particular can be carried out (more) reliably and/or (more) intuitively.

In one embodiment, contact of the robot-fixed reference with an obstacle in the direction of contact is determined if an external force on the robot-fixed reference exceeds, in particular in terms of magnitude, a predetermined limit value that can be set in one embodiment by an operator of the input device and a target direction of movement of the robot-fixed reference desired according to actuation of the actuator comprises a (positive) component (directed) opposite to a direction of this external force or the actuation of the actuator causes a movement of the robot-fixed reference (also) in the direction against this external force if the external force does not exceed the limit value. In one embodiment, the desired target direction of movement of the robot-fixed reference according to actuation of the actuator comprises a portion which corresponds to a difference, possibly normalized, between a target pose of the robot-fixed reference desired according to actuation of the actuator and the current pose of the robot-fixed reference, and may in particular consist of this portion. In one embodiment, the target pose of the robot-fixed reference, desired according to actuation of the actuator, comprises a portion which corresponds to a preceding or previous pose of the robot-fixed reference plus an adjustment of the actuator, scaled in one embodiment, or a difference between a current and a preceding or previous position or pose of the actuator, and can in particular consist of this portion.

In one embodiment, this can reduce the effects of interference when determining the external force, in particular noise, measurement inaccuracies, and the like. Accordingly, in one embodiment the limit value is specified on the basis of a detection accuracy of the external force.

In addition or alternatively, in one embodiment this can prevent undesired switching to contact operating mode, or switching to contact operating mode can take place only in suitable situations or constellations.

In one embodiment, the contact direction is determined on the basis of the external force at the robot-fixed reference, in a development in such a way that the contact direction is opposite to a direction of this force. In one embodiment, an external force on the robot-fixed reference is an external force that acts on the robot-fixed reference and, according to action=reaction, is opposite and equal in magnitude to a force that the robot-fixed reference exerts on the environment.

In one embodiment, this allows the contact direction to be determined advantageously, in particular precisely, reliably, and/or without additional sensors. Additionally or alternatively, in one embodiment, a particularly advantageous contact force component (direction) can thereby be realized and thereby the operation of the telerobotic robot can be improved by an operator, in particular its precision and/or safety.

In one embodiment, the external force at the robot-fixed reference is determined with the aid of at least one distal or end-effector-side force sensor of the telerobotic robot and/or, preferably model-supported, on the basis of joint forces of the telerobotic robot.

In one embodiment, the contact force component of the virtual spring is a function of a current position or pose of the actuator and is determined in particular on the basis of a current position or pose of the actuator.

Additionally or alternatively, the contact force component of the virtual spring in one embodiment is (also) a function of a preceding or initial position or preceding or initial pose of the actuator, is determined in particular on the basis of a preceding or initial position or preceding or initial pose of the actuator.

Additionally or alternatively, the contact force component of the virtual spring in one embodiment is (also) a function of a current pose of the robot-fixed reference, and is determined in particular on the basis of a current pose of the robot-fixed reference.

Additionally or alternatively, the contact force component of the virtual spring in one embodiment (also) depends on a preceding or initial pose of the robot-fixed reference, and is determined in particular on the basis of a preceding or initial pose of the robot-fixed reference.

Additionally or alternatively, the contact force component of the virtual spring in one embodiment (also) depends on a predetermined spring stiffness of the virtual spring, which in one embodiment can be adjusted by an operator of the input device, and is determined in particular on the basis of a predetermined spring stiffness of the virtual spring, which in one embodiment can be adjusted by an operator of the input device.

Additionally or alternatively, the contact force component of the virtual spring in one embodiment (also) depends on a predetermined scaling, which in one embodiment can be set by an operator of the input device, between adjustments of the actuator and movements of the robot-fixed reference, and is determined in particular on the basis of a predetermined scaling, which in one embodiment can be set by an operator of the input device, between adjustments of the actuator and movements of the robot-fixed reference.

In one embodiment, this allows a particularly advantageous spring characteristic of the virtual spring or contact force component or of the simulated contact to be realized, thereby simplifying a teleoperation and/or improving its reliability, in one embodiment.

In one embodiment, the target force in the contact operating mode and/or in the non-contact operating mode comprises a damping component which, in one embodiment, in contact operating mode and non-contact operating mode, is a function in the same way of an adjustment speed of the actuator, and in one embodiment is directed in the opposite direction.

In one embodiment, this can improve handling of the actuator and thereby improve the precision of the teleoperation.

In one embodiment, in the contact operating mode and/or in the non-contact operating mode an external force at the robot-fixed reference, determined by sensors in one embodiment, is not transmitted to the actuator.

As explained elsewhere, a direct force feedback based on external forces determined by sensors at the robot-fixed reference can lead in particular to recoil and/or damage when contacting obstacles. Accordingly, in one embodiment, such force feedback is replaced by the damping component and, if warranted, the contact force component of a virtual spring.

In one embodiment, an external force, detected by sensors, at the robot-fixed reference can include a force that is determined with the aid of at least one distal or end-effector-side force sensor of the telerobotic robot and/or a force that is detected, preferably in model-supported fashion, on the basis of joint forces of the telerobotic robot.

In one embodiment, a target force f_{d,HD} of the actuator is determined, which in the contact-free state, in particular a non-contact operating mode, comprises a damping component that depends on a (current) adjustment speed (dX/dt)_{c,HD} of the actuator:

$${f}_{d , HD} = - D \cdot {( dX / dt )}_{c , HD} \qquad ( 1 )$$

with the damping coefficient D.

In one embodiment, an external force fₑ is detected at the robot-fixed reference. A contact direction u_{f} is then detected in one embodiment according to

$${u}_{f} = - {f}_{e} / ‖ {f}_{e} ‖ . \qquad ( 2 )$$

In one embodiment, a rotation matrix ⁰R_{F} which comprises a coordinate system 0 of Cartesian space and a coordinate system F which is aligned with the contact direction, in one embodiment a z-axis aligned therewith, transformed into one another, is determined, a rotation axis U and a rotation angle θ of this transformation or rotation matrix being determined in one embodiment from

$$U = {[ 001 ]}^{T} \times {u}_{f} \qquad ( 3.1 )$$

$$cos θ = {[ 001 ]}^{T} \cdot {u}_{f} \qquad ( 3.2 )$$

and the rotation matrix ⁰R_{F} from the coordinate system F being transformed into the coordinate system 0, its transposed version (⁰R_{F})^{T} correspondingly being transformed from the coordinate system 0 into the coordinate system F. Of course, instead of the z-axis, a different axis can also be used and this can be taken into account in the corresponding equations.

In one embodiment, a target pose X_{d,r} of the robot-fixed reference for the non-contact operating mode is determined according to

$${X}_{d , r} = ( {X}_{c , HD} - {X}_{ini , HD} ) \cdot s + {X}_{ini , r} \qquad ( 4 )$$

with the current position or pose X_{c,HD} of the actuator, the preceding position or pose X_{ini,HD} of the actuator, the preceding pose X_{ini,r} of the robot-fixed reference and a predefined scaling s between adjustments of the actuator and movements of the robot-fixed reference.

A target direction of movement uₓ of the robot-fixed reference is determined in one embodiment according to

$${u}_{x} = ( {X}_{d , r} - {X}_{c , r} ) / ‖ {X}_{d , r} - {X}_{c , r} ‖ \qquad ( 5 )$$

with the current pose X_{c,r} to the robot-fixed reference and is transformed into the coordinate system F which is oriented to the contact direction:

$${F}^{} {u}_{x} = {( {}^{0} {R}_{F} )}^{T} \cdot {u}_{x} \qquad ( 6 )$$

In one embodiment, a contact of the robot-fixed reference with an obstacle in the contact direction is determined if the magnitude of the external force at the robot-fixed reference exceeds a predefined limit value G and the target movement direction of the robot-fixed reference comprises a (positive) component opposite to a direction of this external force:

$$‖ f ‖ > G and {}^{F} {u}_{x} [ 3 ] > 0 contact \qquad ( 7 )$$

where the index *[3] denotes the z-component of the corresponding vector.

If a contact of the robot-fixed reference with an obstacle in a contact direction or (∥f∥>G and ^{F}uₓ[3]>0) is detected, then in an embodiment a commanding of a movement of the robot-fixed reference in the direction of contact is suppressed:

$${}^{F} {X}_{d , r} = {( {}^{0} {R}_{F} )}^{T} \cdot {X}_{d , r} \qquad ( 8.1 )$$

$${}^{F} {X}_{c , r} = {( {}^{0} {R}_{F} )}^{T} \cdot {X}_{c , r} \qquad ( 8.2 )$$

$${}^{F} {X}_{d , r , cont} = {}^{F} {X}_{d , r} with {}^{F} {X}_{d , r , cont} [ 3 ] = {}^{F} {X}_{c , r} [ 3 ] \qquad ( 8.3 )$$

$${X}_{d , r , cont} = {}^{0} {R}_{F} \cdot {}^{F} {X}_{d , r , cont} \qquad ( 8.4 )$$

In other words, the target pose determined in particular according to (4) X_{d,f} and the current pose of the robot-fixed reference are transformed into the coordinate system F, which is aligned with the contact direction (Equations (8.1), (8.2)), with the transformed target pose ^{F}X_{d,r} whose z-component is fixed to the current pose by occupying or overwriting the z-component with the z-component of the transformed current pose (equation (8.3)), and this modified transformed target pose X_{d,r, cont} is transformed back (Equation (8.3)) and commanded to the controller or drives of the telerobotic robot instead of the non-contact operating mode target pose according to Equation (4).

Additionally or alternatively, in one embodiment, if a contact of the robot-fixed reference with an obstacle in a contact direction or (∥f∥>G and ^{F}uₓ[3]>0) is detected, a contact force component of a virtual spring is added to the target force f_{d,HD} of the actuator determined in accordance with (1), the contact force component of the virtual spring being determined according to:

$${{}^{F} {e}_{HD} = {(}^{0} {R}_{F} )}^{T} \cdot ( {X}_{d , HD} - {X}_{c , HD} ) \qquad ( 9.1 )$$

$${}^{F} {f}_{imp , HD} = 0 \qquad ( 9.2 )$$

$${}^{F} {f}_{imp , HD , cont} = {}^{F} {f}_{imp , HD} with {}^{F} {f}_{imp , HD , cont} [ 3 ] = K \cdot {}^{F} {e}_{HD} [ 3 ] \qquad ( 9.3 )$$

$${f}_{imp , HD} = {}^{0} {R}_{F} \cdot {}^{F} {f}_{imp , HD , cont} \qquad ( 9.4 )$$

with the predetermined spring stiffness K of the virtual spring and the target pose X_{d,HD} of the actuator:

$${X}_{d , HD} = ( {X}_{c , r} - {X}_{ini , r} ) / s + {X}_{ini , HD} \qquad ( 10 )$$

$$is :$$

$${f}_{d , HD , cont} = {f}_{imp , HD} - D \cdot {( dX / dt )}_{c , HD} \qquad ( 11 )$$

In other words, first a virtual spring force is first determined which only comprises a positive or pressure contact force component in the direction opposite to the contact direction (equations (9.1)-(9.3), (10)), and this is transformed back (equation (9.4)), added to the non-contact operating mode target force f_{d,HD} according to equation (1) (equation (11)), and this contact operating mode target force f_{d,HD, cont} is commanded to the control or drives of the input device according to equation (11). As mentioned elsewhere, in one embodiment K=K(fₑ).

The following generally holds for the contact force component of the virtual spring(s) in one embodiment (see in particular equations (9.1), (9.3)):

$${f}_{imp , HD} = K \cdot ( {X}_{d , HD} - {X}_{c , HD} ) \qquad ( 12 )$$

According to one embodiment of the present invention, a system, in particular in terms of hardware and/or software, in particular in terms of programming, is configured to perform a method described herein and/or comprises:
means for commanding a target pose of a robot-fixed reference of the telescopic robot on the basis of a detected position of the actuator;
means for commanding a target force of the actuator; and
means for performing a contact operating mode if a contact of the robot-fixed reference with an obstacle is detected in a contact direction, and a non-contact operating mode after this contact is no longer detected and/or before this contact is detected,
wherein in the contact operating mode the target force comprises a contact force component of a virtual spring which simulates a contact of the robot-fixed reference with an obstacle, and this contact force component is omitted in the non-contact operating mode.

In one embodiment, the system or its means comprises:
means for reducing, in particular suppressing, a commanding of a movement of the robot-fixed reference in the contact direction in the contact operating mode relative to a commanding of a movement of the robot-fixed reference in the same direction in the non-contact operating mode; and/or
means for detecting a contact of the robot-fixed reference with an obstacle in the direction of contact if an external force at the robot-fixed reference exceeds a predetermined limit value and a direction of movement of the robot-fixed reference desired according to actuation of the actuator comprises a component opposite to a direction of this external force; and/or
means for detecting the contact direction on the basis of the external force at the robot-fixed reference, in particular in such a way that the contact direction is opposite to a direction of this force.

A system and/or a means within the meaning of the present invention may be designed in hardware and/or in software, and in particular may comprise at least one in particular digital processing unit, in particular a microprocessor unit (CPU), graphic card (GPU), or the like, that is preferably connected in terms of data or signals to a memory and/or bus system, and/or may comprise one or more programs or program modules. The processing unit may be designed to process commands that are implemented as a program stored in a memory system, to detect input signals from a data bus and/or to output output signals to a data bus. A storage system may comprise one or a plurality of, in particular different, storage media, in particular optical, magnetic, solid-state, and/or other non-volatile media. The program may be designed in such a way that it embodies or is capable of carrying out the methods described herein, so that the processing unit is able to carry out the steps of such methods and thus, in particular, is able to operate the telerobotic robot. In one embodiment, a computer program product may comprise, in particular be, a storage medium, in particular computer-readable and/or non-volatile, for storing a program or instructions or with a program stored thereon or with instructions stored thereon. In one embodiment, execution of said program or instructions by a system or controller, in particular a computer or an arrangement of multiple computers, causes the system or controller, in particular the computer or computers, to carry out a method described herein or one or more steps thereof, or the program or instructions are set up to do so.

In one embodiment, one or more, in particular all, steps of the method are performed completely or partially automatically, in particular by the system or its means.

In one embodiment, the system includes the telerobotic robot and/or its robot controller and/or the input device.

A contact, in the sense of the present invention, is understood to mean, in particular in a manner known per se, a one-sided contact or the touching of two surfaces.

In one embodiment, the target pose, and in a development the commanding and/or the approaching of the target pose, is realized with the aid of a position, speed, or force controlling in the joint space or space of the joint coordinates of the telerobotic robot. This allows the telerobotic robot, in one embodiment, to be operated advantageously, in particular (more) precisely, (more) simply, and/or (more) reliably.

### BRIEF DESCRIPTION OF THE DRAWINGS

The accompanying drawings, which are incorporated in and constitute a part of this specification, illustrate exemplary embodiments of the invention and, together with a general description of the invention given above, and the detailed description given below, serve to explain the principles of the invention.

FIG. 1 schematically depicts a system for controlling a telerobotic with the aid of an input device according to one embodiment of the present invention; and

FIG. 2 illustrates a method for controlling the telerobotic robot using the input device according to an embodiment of the present invention.

### DETAILED DESCRIPTION

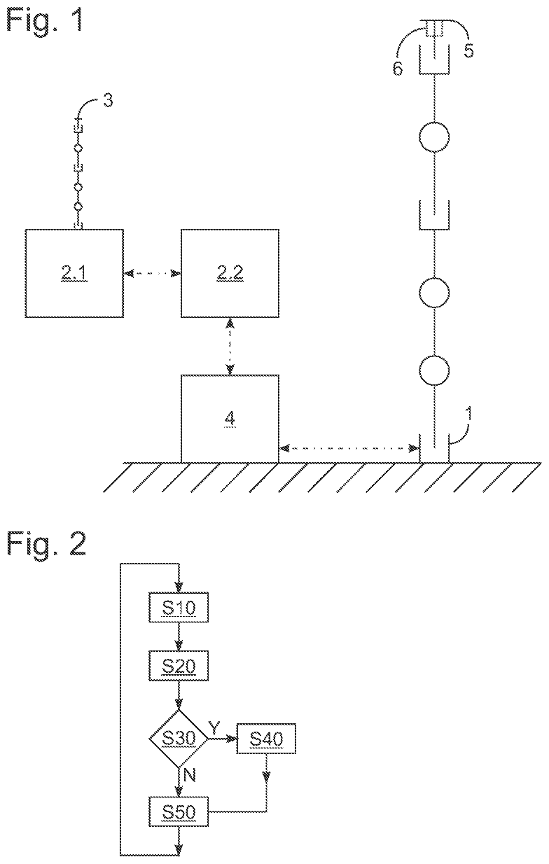

FIGS. 1, 2 show a system or method according to one embodiment of the present invention for controlling a telerobotic robot (arm) 1 by means of an input device, comprising a base 2.1, an actuator 3 movable relative to the base 2.1, and an input device controller 2.2, via a robot controller 4 which communicates wirelessly or in wire-bound fashion with the input device controller 2.2. The input device controller 2.2 can be integrated into the base 2.1.

In a step S10, a current pose of the actuator 3 relative to the input device 2.1, and, in one embodiment, with the aid of at least one distal or end-effector-side force sensor 6 of the telerobotic robot (arm) or in model-supported fashion on the basis of joint forces of the telerobotic robot (arm), an external force fₑ at a robot-fixed reference in the form of an end effector 5, are detected by sensors. In addition, a current position or pose X_{c,HD} of the actuator and a current pose X_{c,r} of the end effector 5 are determined, whereby the (current) adjustment speed (dX/dt)_{c,HD} is determined, in one embodiment, by time differentiation of the current position or pose X_{c,HD} or, conversely, the current position or pose X_{c,HD} is determined by time integration.

In a step S20, a non-contact operating mode target force f_{d,HD} of the actuator 3 and a non-contact operating mode target pose X_{d,r} of the robot-fixed reference 5 are determined according to equations (1), (4) above.

In addition, according to the above equations (2), (3.1), (3.2), (5), (6), a contact direction u_{f}, a rotation matrix ⁰R_{F} with rotation axis U and rotation angle θ, and a component of a target movement direction in a direction opposite to the contact direction are detected.

In a step S30, it is determined according to the above equations (7) whether there is contact between the robot-fixed reference 5 and an obstacle in the direction of contact.

If this is the case (S30: “Y”), a switch is made to a contact operating mode and, in accordance with equations (8.1)-(8.4) above, a commanding a movement of the robot-fixed reference in the contact direction is suppressed and, in accordance with equations (9.1)-(12) above, a contact force component of a virtual spring is added to the non-contact mode target force f_{,d,HD} of the actuator, which simulates a contact of the robot-fixed reference 5 with an obstacle (step S40), and then in a step S50 the corresponding contact mode target pose of the robot-fixed reference 5 and contact mode target force of the actuator 3 are commanded.

Otherwise (S30: “N”), i.e. in a non-contact operating mode to which a switch back is made if necessary (S30: “N”), the non-contact operating mode target pose of the robot-fixed reference 5 determined in step S20 and the non-contact operating mode target force of the actuator 3 are commanded (step S50), so that the contact force component of the virtual spring and the suppression of a movement in the contact direction are omitted.

The method then returns to step S10, the previous current position of actuator 3 forming the new preceding position of actuator 3 and the previous current pose of end effector 5 forming the new preceding pose of end effector 5.

It will be seen that in the contact operating mode and in the non-contact operating mode, a commanding of a movement of the robot-fixed reference in a direction perpendicular to the contact direction is the same and/or in the contact operating mode and in the non-contact operating mode, a commanding of a movement of the robot-fixed reference in a direction opposite to the contact direction is the same.

Although embodiments have been explained in the preceding description, it is noted that a large number of modifications are possible. It is also noted that the embodiments are merely examples that are not intended to restrict the scope of protection, the applications, and the structure in any way. Rather, the preceding description provides a person skilled in the art with guidelines for implementing at least one embodiment, various changes—in particular with regard to the function and arrangement of the described components—being able to be made without departing from the scope of protection as it arises from the claims and from these equivalent combinations of features.

While the present invention has been illustrated by a description of various embodiments, and while these embodiments have been described in considerable detail, it is not intended to restrict or in any way limit the scope of the appended claims to such de-tail. The various features shown and described herein may be used alone or in any combination. Additional advantages and modifications will readily appear to those skilled in the art. The invention in its broader aspects is therefore not limited to the specific details, representative apparatus and method, and illustrative example shown and described. Accordingly, departures may be made from such details without departing from the spirit and scope of the general inventive concept.

### LIST OF REFERENCE SIGNS

1 Telerobotic robot (arm)
2.1 Input device base
2.2 Input device controller
3 Actuator
4 Robot controller
5 End effector (robot-fixed reference)
6 Force sensor

What is claimed is:

1-10. (canceled)

11. A method for controlling a telerobotic robot using an input device which includes a movable actuator, the method comprising:
commanding with the input device a target pose of a robot-fixed reference of the telerobotic robot based on a detected position of the actuator;
commanding a target force of the actuator;
operating the robot in a non-contact operating mode while no contact with an obstacle is detected, or after contact with an obstacle is no longer detected; and
operating the robot in a contact operating mode in response to detecting a contact of the robot-fixed reference with an obstacle while moving in a contact direction;
wherein, in the contact operating mode, the target force comprises a contact force component of a virtual spring that simulates a contact of the robot-fixed reference with an obstacle; and
in the non-contact operating mode, the contact force component is omitted.

12. The method of claim 11, wherein the steps of the method are repeated at least once, in sequence.

13. The method of claim 11, wherein:
in the contact operating mode, a commanding of a movement of the robot-fixed reference in the contact direction is reduced relative to a commanding of the movement of the robot-fixed reference in the contact direction in the non-contact operating mode.

14. The method of claim 13, wherein the commanding of the movement of the robot-fixed reference in the contact direction is suppressed in the contact operating mode.

15. The method of claim 11, wherein at least one of:
a commanding of a movement of the robot-fixed reference in a direction perpendicular to the contact direction is the same for operation of the robot in the contact operating mode and in the non-contact operating mode; or
a commanding of a movement of the robot-fixed reference in a direction opposite to the contact direction is the same for operation of the robot in the contact operating mode and in the non-contact operating mode.

16. The method of claim 11, further comprising:
detecting a contact of the robot-fixed reference with an obstacle in the direction of contact in response to an external force on the robot-fixed reference exceeding a predetermined limit value and a direction of movement of the robot-fixed reference according to actuation of the actuator comprises a component opposite to a direction of the external force.

17. The method of claim 11, further comprising determining the contact direction based on the external force at the robot-fixed reference.

18. The method of claim 17, wherein the contact direction is determined in a direction opposite to a direction of the external force.

19. The method of claim 11, wherein the contact force component of the virtual spring is a function of at least one of:
a current and/or previous position of the actuator;
a current and/or previous pose of the robot-fixed reference;
a predetermined spring stiffness of the virtual spring; or
a predetermined scaling between adjustments of the actuator and movements of the robot-fixed reference.

20. The method of claim 11, wherein the target force, at least in the contact operating mode, comprises a damping component that is a function of a speed at which the actuator is adjusted.

21. The method of claim 11, wherein the target force in the non-contact operating mode comprises a damping component that depends on a speed at which the actuator is adjusted.

22. The method of claim 21, wherein the target force in the non-contact operating mode comprises a damping component that depends on a speed at which the actuator is adjusted in the same way as in the contact operating mode.

23. The method of claim 11, wherein, in at least one of the contact operating mode or in the non-contact operating mode, an external force at the robot-fixed reference is not transmitted to the actuator.

24. A system for controlling a telerobotic robot using an input device which includes a movable actuator, the system comprising an input device controller that comprises:
means for commanding a target pose of a robot-fixed reference of the telerobotic robot based on a detected position of the actuator;
means for commanding a target force of the actuator; and
means for operating the robot:
in a non-contact operating mode while no contact with an obstacle is detected, or after contact with an obstacle is no longer detected, and
in a contact operating mode in response to detecting a contact of the robot-fixed reference with an obstacle while moving in a contact direction;
wherein, in the contact operating mode, the target force comprises a contact force component of a virtual spring that simulates a contact of the robot-fixed reference with an obstacle; and
in the non-contact operating mode, the contact force component is omitted.

25. A computer program product for controlling a telerobotic robot using an input device that includes a movable actuator, the computer program product comprising program code stored on a non-transitory, computer-readable medium, the program code, when executed on a computer, causing the computer to:
command a target pose of a robot-fixed reference of the telerobotic robot based on a detected position of the actuator;
command a target force of the actuator;
operate the robot in a non-contact operating mode while no contact with an obstacle is detected, or after contact with an obstacle is no longer detected; and
operate the robot in a contact operating mode in response to detecting a contact of the robot-fixed reference with an obstacle while moving in a contact direction;
wherein, in the contact operating mode, the target force comprises a contact force component of a virtual spring that simulates a contact of the robot-fixed reference with an obstacle; and
in the non-contact operating mode, the contact force component is omitted.
